(19) United States
(12) Patent Application Publication
(10) Pub. No.: US 2012/0198723 A1
(43) Pub. Date: Aug. 9, 2012

(54) THERAPEUTIC SHOE

(75) Inventor: Boris Borisov, Timonium, MD (US)

(73) Assignee: B & S Partners, Inc. d/b/a Pilgrim Shoes, Baltimore, MD (US)

(21) Appl. No.: 13/024,134

(22) Filed: Feb. 9, 2011

(51) Int. Cl. A43B 7/22; B29D 35/06; A43B 7/14

(52) U.S. Cl. 36/91; 36/88; 36/92; 264/244

(57) ABSTRACT

A therapeutic shoe in accordance with the present invention includes an upper; an outsole attached to the upper; and a carbon fiber plate embedded in situ within the sole during a common molding process that forms the outsole, the carbon fiber plate being anatomically correct and extending at least a substantial length of a footbed of the shoe. A bottom surface of the carbon fiber plate is intimately bonded to the outsole.

### TECHNICAL FIELD

The present invention relates to shoes and in particular, to a therapeutic shoe that is particularly constructed for use with diabetic individuals or individuals that require a therapeutic shoe.

### BACKGROUND

There are a number of different shoes that are marketed to different people for different settings. For example, there is a vast number of athletic shoes (sneakers) that are designed for use in different sports and likewise there is a vast number of dress shoes for wearing at the office, social events, etc.

One other class of shoes is often referred to as therapeutic shoes that are designed in view of a particular condition that a wearer may suffer from. A related field is the field of orthotics and orthotic products which are customized in view of an individuals foot profile to provide a shoe that provides a better fit and support for the individual who suffers from some foot condition, such as low foot arches, etc. With respect to therapeutic shoes, diabetic shoes are one type of therapeutic shoe and are sometimes referred to as extra depth shoes. Diabetic shoes are specially designed shoes or inserts intended to reduce the risk of skin breakdown in diabetics with co-existing foot disease.

Individuals with decreased feeling in their feet may have a false sense of security as to how much at risk their feet actually are. An ulcer under the foot can develop in a couple of hours. The primary goal of therapeutic footwear is to prevent complications, such as: strain, ulcers, calluses, or even amputations for patients with diabetes and poor circulation. In addition to meeting strict guidelines, diabetic shoes must be prescribed by a physician and fit by a qualified individual, such as a certified pedorthist. The shoes must also be equipped with a removable orthotic. Foot orthotics are devices such as shoe inserts, arch supports, or shoe fillers such as lifts, wedges and heels. The diabetic shoes and customized insoles work together as a preventative system to help diabetics avoid foot injuries and improve mobility.

Typically, there are two types of diabetic shoes: custom molded and depth shoes; however, other shoes can be marketed. Custom molded shoes are shoes that are: constructed over a positive model of the wearer's foot; have removable inserts that can be altered or placed as the wearer's condition warrants; and have some form of shoe closure, such as lace or hook and loop material. Depth shoes are shoes that have a full length heel to toe liner that, when removed, provides a minimum of 3/16 inch of additional depth used to accommodate custom molded or customized inserts and have some form of shoe closure, such as lace or hook and loop material.

There is a need for an alternative therapeutic shoe that provides ambulatory help for certain foot conditions and overcomes disadvantages associated with the prior art.

### SUMMARY

A therapeutic shoe in accordance with the present invention includes an upper; an outsole attached to the upper; and a carbon fiber plate embedded in situ within the sole during a common molding process that forms the outsole, the carbon fiber plate being anatomically correct and extending at least a substantial length of a footbed of the shoe. A bottom surface of the carbon fiber plate is intimately bonded to the outsole.

The outsole has a heel portion that is defined by a first centermost region and a second peripheral region that is disposed around the first region. The first centermost region is an at least substantially planar region, while the second peripheral region is an inwardly beveled surface toward the first centermost region.

The material and construction of the outsole permit flexing of the outsole such that when a heel strike force is applied, the first centermost region flattens out such that a bottom surface of the first and second regions are substantially coplanar. In other words, the second peripheral region is beveled to a degree such that when a heel strike force is applied, the second peripheral region flattens and assumes a position in which the second peripheral region is at least substantially coplanar with the first centermost region to provide support to the wearer. As a result, the outsole is configured such that when a heel strike occurs, a bottom of the outsole spreads outwardly, while a top portion of the outsole inwardly pinches to apply a force to a heel area of the wearer, thereby cradling the heel area.

These and other aspects, features and advantages shall be apparent from the accompanying Drawings and description of certain embodiments of the invention.

### BRIEF DESCRIPTION OF THE DRAWINGS

FIG. 1 is a side perspective view of a therapeutic shoe according to one embodiment of the present invention;

FIG. 2 is a side and top perspective view of a carbon fiber plate that is incorporated into the therapeutic shoe of FIG. 1;

FIG. 3A is a cross-sectional view of the therapeutic shoe of FIG. 1 prior to a heel strike action by the wearer;

FIG. 3B is a cross-sectional view of the therapeutic shoe of FIG. 1 showing a heel strike action by the wearer;

FIG. 4A is a bottom plan view of the outsole of the therapeutic shoe of FIG. 1;

FIG. 4B is an end perspective view of the outsole of therapeutic shoe of FIG. 1;

FIG. 5 is a side elevation view of the therapeutic shoe of FIG. 1 with the carbon fiber plate being exploded therefrom; and

FIG. 6 is a cross-sectional view taken longitudinally through the therapeutic shoe showing the carbon fiber plate integrally incorporated into the shoe.

### DETAILED DESCRIPTION OF CERTAIN EMBODIMENTS OF THE INVENTION

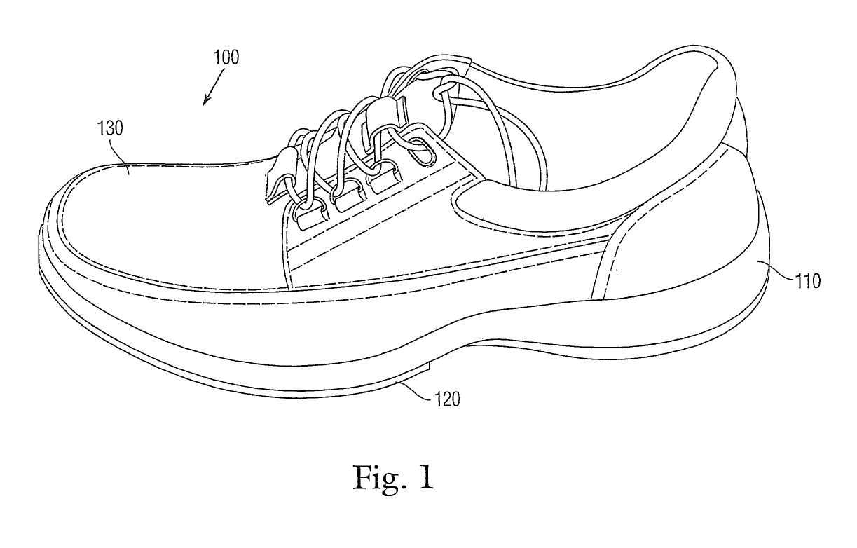

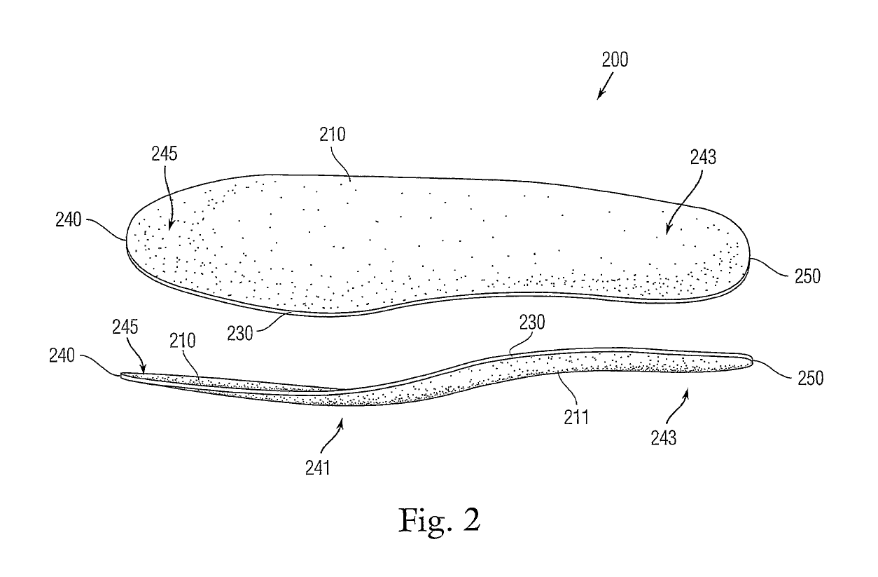

FIG. 1 is a perspective view of a therapeutic shoe 100 according to one exemplary embodiment of the present invention. Like other shoes, the shoe 100 is formed of a number of materials and pieces that are joined to together to form the assembled shoe 100. The shoe 100 is a specialty shoe that is directed to the foot specialist market (e.g., podiatry, pedorthics, etc.) to allow ambulatory help for certain foot conditions. For example, the shoe 100 provides ambulatory help in correcting the wearer's gait, assisting in limited range of motion, etc.

The shoe 100 has a sole portion 110 which represents the bottom of the shoe 100. Shoe 100 has an insole which represents the interior bottom of the shoe 100 and sits directly beneath the foot under the footbed. The purpose of the insole is to attach to the lasting margin of the upper which is wrapped around the last during the closing of the shoe 100 during the lasting operation. Insoles are usually made of cellulosic paper board or synthetic non woven insole board. Shoe 100 can be constructed to have a removable and replaceable footbed. Extra cushioning can be added for comfort (to control the shape, moisture, or smell of the shoe) or health reasons (to help deal with defects in the natural shape of the foot or positioning of the foot during standing or walking). Footbeds also typically use foam cushioning sheets to provide good wearing comfort of the shoe.

The outsole 120 of the shoe 100 is the layer in direct contact with the ground. Dress shoes often have leather or resin rubber outsoles; casual or work-oriented shoes have outsoles made of natural rubber or a synthetic material like polyurethane. The outsole 120 can comprise a single piece, or may be an assembly of separate pieces of different materials. The bottom rear part of a shoe is the heel. Its function is to support the heel of the foot. As in the present embodiment, the heel is often made of the same material as the sole of the shoe.

The shoe 100 has an upper part 130 that helps hold the shoe 100 onto the foot. In the simplest cases, such as sandals or flip-flops, this may be nothing more than a few straps for holding the sole in place. Closed footwear, such as shoe 100, has a more complex upper. This part is often decorated or is made in a certain style to look attractive.

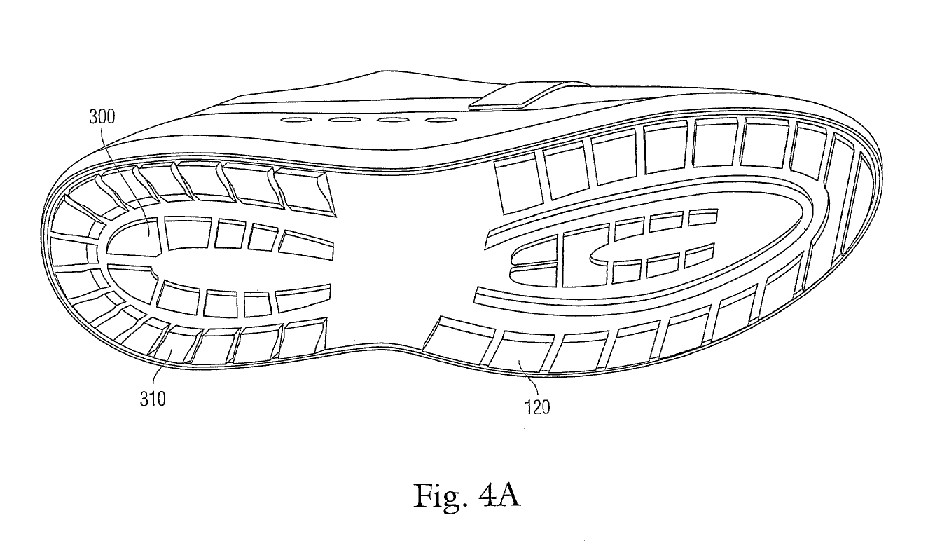

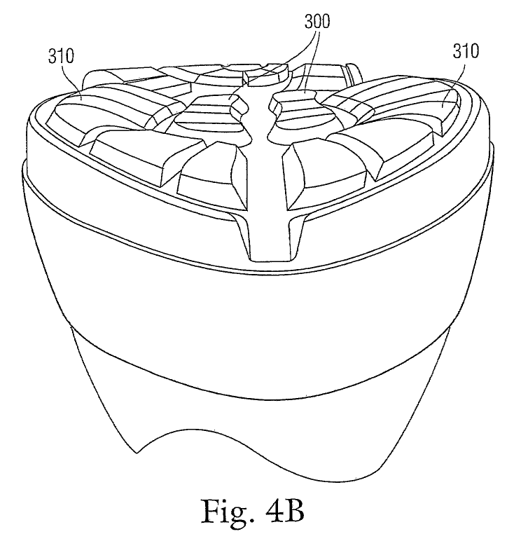

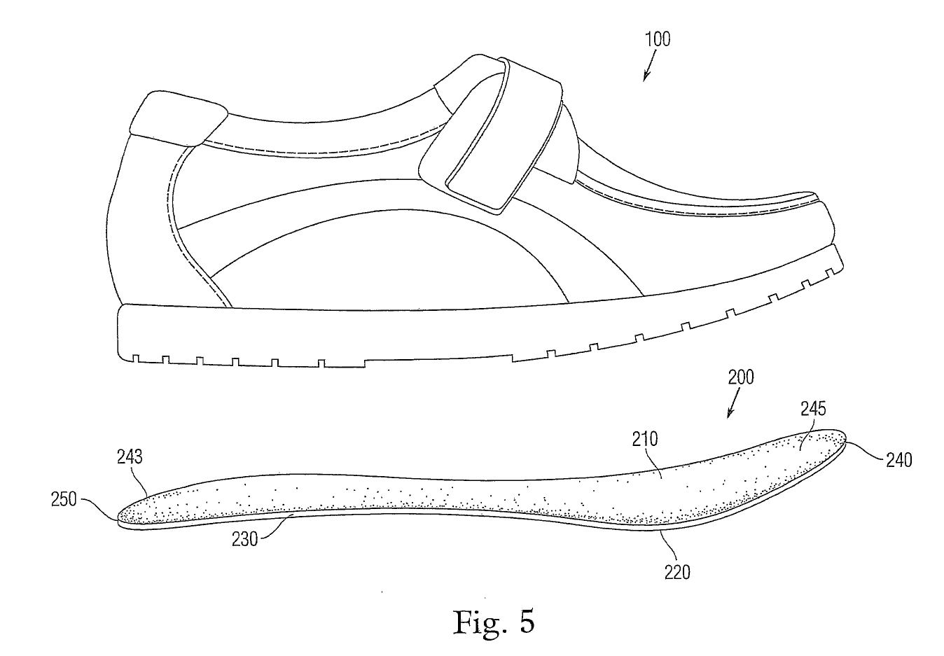

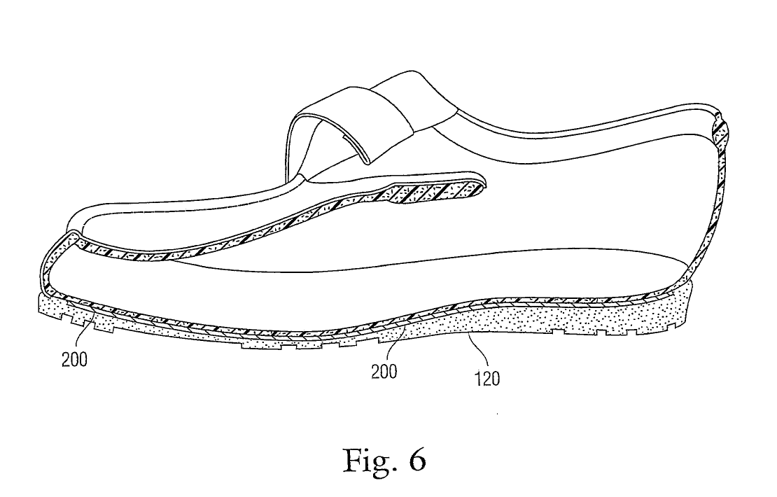

The outsole of the shoe of the present invention is uniquely designed to provide a number of advantages. In particular and as best shown in FIGS. 4A and 4B, the outsole has at least two distinct regions and in particular, the outsole 120 has a first region 300 and a second region 310. The first region 300 represents a centermost region of the outsole, while the second region 310 represents a peripheral outer region of the outsole. As shown in FIG. 4B, the second region 310 is beveled and angled inward toward the center of the outsole (toward first region 300), while the first region 300 is at least substantially planar in nature. The heel region of the outsole thus tapers inwardly from the peripheral side to the centermost portion of the outsole. The heel portion of the outsole 120 has a different construction compared to the toe portion which is relatively flat or planar across its width as opposed to the beveled heel portion of the outsole 120. Due to the beveled nature of the heel portion, the shoe 100 can be described as providing a heel cradle system that provides the advantages described below.

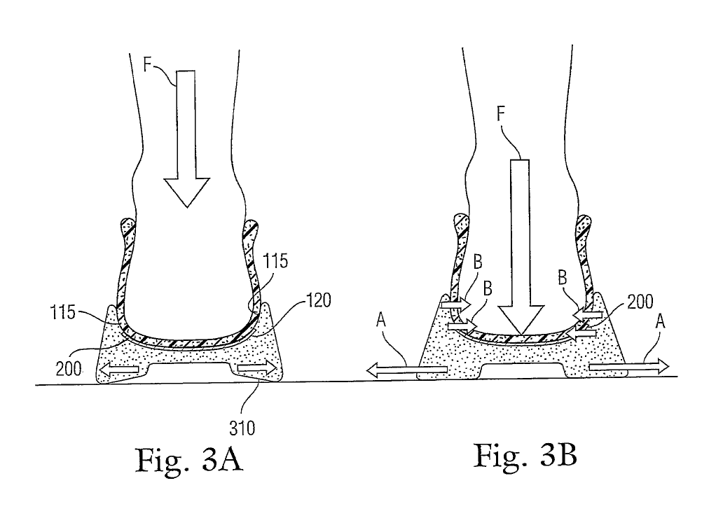

For ease of clarity, all of the details of the first region 300 are not shown in FIGS. 3A and 3B.

FIG. 3A shows the shoe 100 prior to a heel strike by the wearer. As can be seen in this figure, the beveled construction of the outsole 210 causes the heel portion of the outsole 120 to only make contact with the ground in select locations prior to downward force (i.e., a heel strike force) being applied by the wearer. More particularly, the outsole 120 is in contact with the ground only in the second region 310 that represents the outermost (peripheral) areas of the outsole 120. In addition, as shown in FIG. 3A, the entire second region 310 may not be in contact with the ground but instead only the outermost edge portions of the second region 310 may be in contact with the ground. The centermost first region 300 is not in contact with the ground.

In this position, the outsole 120 has a first width X as measured across the heel portion of the outsole 120.

FIG. 3B shows the shoe 100 after a heel strike by the wearer which is represented by the downward force F1 (represented by the downward facing arrow F) being applied to the shoe 100. Once will appreciate that the downward facing arrow in FIG. 3A is located higher than the arrow shown in FIG. 3B since FIG. 3B represents when the wearer's full weight is applied to the shoe 100.

In this second position after the downward force F1 is applied to the shoe 100 in the heel portion thereof (e.g., as occurs in a normal heel strike action), the width of the outsole 120, across the heel, changes and more particularly, the outsole 120 assumes a second width Y that is greater than the first width X. This results due to the sole 110 flattening out and the first and second regions 300, 310 come into contact with the ground and lie flush against the ground as shown.

In particular, the beveled nature of the second region 310 flattens out resulting in the first region 300 moving toward and preferably into contact with the ground. Thus, with a full heel strike, the first and second regions 300, 310 come into a planar arrangement and are in contact with the ground during the heel strike action.

The flattening out of the outsole 120 is represented by arrows A in FIG. 3B which shows the outsole 120 moving in an outward direction. At the same time, an inward force, near and at the top of the sole represented by arrows B in FIG. 3B is generated.

In effect, there is a pivoting action of the sole when a heal strike occurs that results in the beveled surfaces of the first and second regions 300, 310 pivoting downward into contact with the ground (in a flush manner) as shown in FIG. 3B, while an upper portion 115 of the outsole 120 pivots inward toward the center of the shoe 100. This pivoting action causes the upper portion 115 of the sole 110 to apply more of a force to the wearer's foot resulting in increased fit and support. The inwardly directed force (arrows B) not only serves to pinch or cradle the heel in a securely held position but also in the case of some patients, can assist in physically stimulating the foot to aid in blood flow, etc.

It will be appreciated that when the wearer lifts his or her foot, the resilient nature of the polymeric material that forms the sole 110 causes the sole 110 to assume the position shown in FIG. 3A until the user strikes the surface again (heel strike) when the outsole 120 will assume the position shown in FIG. 3B. This action (i.e., the movement of the outsole 120 between the positions shown in FIGS. 3A and 3B) continues as the wearer takes steps, etc.

This “heel cradle system” of the sole 110 is designed to provide optimal support and comfort to the wearer and in combination with a carbon fiber plate 200 provides a shoe that provides ambulatory help (therapeutic benefit) for certain foot conditions.

The carbon fiber plate 200 is a carbon fiber-reinforced polymer composite that is very strong and light. The composite is formed of reinforcing fibers (carbon fibers) and a polymer (e.g., epoxy).

The carbon fiber plate 200 includes a top surface 210, an opposing bottom surface 220 and peripheral sides 230. The carbon fiber plate 200 is intended to extend the entire length of the footbed of the shoe 100 and therefore the carbon fiber plate 200 has a first end 240 which represents a toe portion and an opposing second end 250 which represents the heel portion of the shoe 100. More specifically, the carbon fiber plate 200 includes an arch region 241, a heel cup region 243 and toe region 245.

In contrast to most conventional carbon fiber plate products, the carbon fiber plate 200 of the present invention is shaped anatomically in view of the foot of a target wearer, i.e., someone that needs a therapeutic shoe. The carbon fiber plate 200 is consequently not a flat plate but rather it has three-dimensional contours. For example, the peripheral sides 230 tend to be higher than the middle (center) portion of the carbon fiber plate 200 and the width of the plate increases in the toe area (near and at first end 240) so that when worn the entire foot of the wearer is disposed over the carbon fiber plate 200.

The second end 250 of the carbon fiber plate 200 is formed and shaped as a heel cup area to allow for even weight distribution and serves as a shock absorption piece. The first end 240 of the carbon fiber plate 200 is resilient and has spring-like properties to assist patients with limited range of motion of metatarsal heads.

Generally, the carbon fiber plate 200 has a concave shape as viewed in cross-section across a width of the plate 200 from one end to the other end. The peripheral sides 230 thus represent the highest points of a cross-sectional slice taken across the plate 200. This shape is meant to provide an anatomically correct footbed.

The heel cup region 243 of the carbon fiber plate 200 allows for even weight distribution and serves as a shock absorption piece. The toe region 245 is formed to be resilient (springy) to assist patients with limited range of motion of metatarsal heads.

The carbon fiber plate 200 is used in conjunction with the heel cradle system construction of the heel area of the outsole 110 as described herein to advantageously provide a number of benefits to the wearer.

In one embodiment, the carbon fiber plate 200 can be a multi-layer structure. For example, the carbon fiber plate 200 can be constructed of four layers that overlap one another.

In one embodiment, the carbon fiber plate 200 is a homogenous structure from one end to the other end in that the plate construction does not vary; however, the shape varies based on anatomical concerns.

The carbon fiber plates 200 can be provided in different rigidities and can easily be incorporated into the sole 110 of the shoe 100 and provide a practitioner (doctor, pedorthist, orthotist) with a simple solution for solving the patient's needs. The carbon fiber plate 200 carries custom (to the patient's diagnosis) features and when placed into the sole 110 eliminates the need of having a special shoe (with extra depth and removable insole). In addition, it will be appreciated that an insole placed in the shoe will move around as the patient walks and that can have a harmful effect in certain cases. In contrast and according to the present invention, the carbon fiber plate 200 (insert) is placed directly into the sole 110 and therefore, does not move around and consequently, provides a stable, fixed article within the shoe.

In accordance with one embodiment of the present invention, the carbon fiber plate 200 is disposed within the shoe 100 during a common molding process in which the sole 110 is formed. In particular, the sole 110 is preferably formed of a moldable material and is fabricated using a molding process, such as an injection molding process. More specifically, the carbon fiber plate 200 can be inserted into a mold, such as an injection mold, and the mold is then closed such that a cavity exists below and around the peripheral sides 230 of the carbon fiber plate 200. The moldable material, such as an injection moldable polymeric material, is then injected into the mold around the carbon fiber plate 200 such that the sole 110 is formed underneath and around the peripheral sides 230 of the carbon fiber plate 200. In one embodiment, the moldable polymeric material does not flow over the top surface of the carbon fiber plate 200 but rather is limited to being disposed around and in intimate bonding contact with the side edge and the bottom surface thereof. In another embodiment, the moldable polymeric material is disposed over the top surface of the carbon fiber plate so as to fully encapsulate the carbon fiber plate. Thus, a thin layer of polymeric material can be disposed over the carbon fiber plate and provides the surface on which another layer, as described below, can be placed.

A layer, such as an insole or the like, is then disposed over the carbon fiber plate 200 to provide a comfortable footbed for the wearer's foot. For example, conventional cushioning material is disposed over the carbon fiber plate 200. The upper is also attached during or subsequent to the molding process in which the sole is formed and the carbon fiber plate 200 is strategically encapsulated within the sole.

The combination of the anatomically correct, full length carbon fiber plate 200 and the heel cradle system of the outsole 120 provides synergistic effects and provides a therapeutic shoe that offers improved stability and support for the target patient in need of a therapeutic shoe. This results from not only the shape of the heel portion of the carbon fiber plate but also from the unique sole construction that has a changeable shape in the heel portion when a heel strike occurs and the “flattening out” of the heel portion results in a heel cradle force (arrows B) being applied to the heel as discussed herein.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A therapeutic shoe comprising:
an upper;
an outsole attached to the upper; and
a carbon fiber plate embedded in situ within the sole during a common molding process that forms the outsole, the carbon fiber plate being anatomically correct and extending at least a substantial length of a footbed of the shoe, wherein a bottom surface of the carbon fiber plate is intimately bonded to the outsole.

2. The shoe of claim 1, wherein the carbon fiber plate has a concave shape and includes a heel cradle portion, an arch portion, and a toe bed portion.

3. The shoe of claim 1, wherein the carbon fiber plate is disposed proximate an upper surface of the outsole.

4. The shoe of claim 1, wherein material that forms the outsole extends around the peripheral sides of the carbon fiber plate but remains substantially free of contact with a top surface of the carbon fiber plate.

5. The shoe of claim 1, further including an insole disposed over the carbon fiber plate.

6. The shoe of claim 1, wherein the outsole has a heel portion that is defined by a first centermost region and a second peripheral region that is disposed around the first region, the first centermost region being an at least substantially planar region, while the second peripheral region is an inwardly beveled surface toward the first centermost region.

7. The shoe of claim 1, wherein the material and construction of the outsole permit flexing of the outsole such that when a heel strike force is applied, the second peripheral region flattens out such that a bottom surface of the first and second regions are substantially coplanar.

8. The shoe of claim 7, wherein the second peripheral region is beveled to a degree such that when a heel strike force is applied, the second peripheral region flattens and assumes a position in which the second peripheral region is at least substantially coplanar with the first centermost region to provide support to the wearer.

9. The shoe of claim 1, wherein the outsole is configured such that when a heel strike occurs, a bottom of the outsole spreads outwardly, while a top portion of the outsole inwardly pinches to apply a force to a heel area of the wearer, thereby cradling the heel area.

10. A method of manufacturing a shoe comprising the steps of:
inserting a carbon fiber plate into a mold, the carbon fiber plate having a bottom surface, a top surface and peripheral sides;
placing a shoe upper with the mold with the shoe upper being proximate the peripheral sides of the carbon fiber plate; and
injecting a moldable material into the mold to form an outsole of the shoe, wherein the moldable material surrounds the peripheral sides of the carbon fiber plate and a bottom of the carbon fiber plate intimately bonds with the moldable material.

11. A therapeutic shoe comprising:
an upper; and
an outsole attached to the upper, wherein the outsole has a heel portion that is defined by a first centermost region and a second peripheral region that is disposed around the first region, the first centermost region being an at least substantially planar region, while the second peripheral region is inwardly beveled in a direction toward the first centermost region, wherein the heel portion of the outsole is constructed of a material and a degree of the bevel is selected such that when a heel strike force is applied, the inwardly beveled second peripheral region flattens out such that bottom surfaces of the first and second regions are substantially coplanar.

12. The shoe of claim 11, further including a carbon fiber plate embedded in situ within the sole during a common molding process that forms the outsole, the carbon fiber plate being anatomically correct and extending at least a substantial length of a footbed of the shoe, wherein a bottom surface of the carbon fiber plate is intimately bonded to the outsole.
